(19) United States
(12) Patent Application Publication
(10) Pub. No.: US 2026/0030514 A1
(43) Pub. Date: Jan. 29, 2026

(54) SYSTEM AND METHOD FOR DEPLOYING AND CONTROLLING ARTIFICIAL INTELLIGENCE AGENTS

(71) Applicant: KPMG LLP, New York, NY (US)

(72) Inventors: Bradley JENKINS, New York, NY (US); Ginger LUCKEY, New York, NY (US)

(21) Appl. No.: 19/281,252

(22) Filed: Jul. 25, 2025

Related U.S. Application Data
(60) Provisional application No. 63/675,427, filed on Jul. 25, 2024.

(51) Int. Cl. G06N 3/0985; G06N 3/092

(52) U.S. Cl. CPC G06N 3/0985; G06N 3/092

(57) ABSTRACT

An agent deployment system for adaptively managing artificial intelligence agents within an enterprise computing environment. The system can include an agent subsystem having a control agent configured to receive source data from one or more data sources of the enterprise, continuously monitor the source data for an occurrence of a trigger event indicative of a condition requiring an AI based intervention, detect the trigger event, evaluate the trigger event to identify a relevant operational context, and then based on the trigger event and the operational context, select and deploy the plurality of AI agents from a total set of AI agents to address the trigger event by performing an AI-based intervention.

### RELATED APPLICATION

The present application claims priority to U.S. provisional patent application Ser. No. 63/675,427, filed on Jul. 25, 2024, and entitled System and Method for Deploying and Controlling Artificial Intelligence Agents, the contents of which are herein incorporated by reference.

### BACKGROUND OF THE INVENTION

The present invention generally relates to the use of artificial intelligence (AI) agents, and more particularly relates to systems and methods for deploying and enhancing the functionality and performance of AI agents in various applications and environments.

In recent years, there has been a surge in the development and deployment of AI agents across various industries and domains. The AI agents, also referred to as virtual assistants or chatbots, are designed to perform tasks autonomously, simulate human-like interactions, and provide valuable assistance to users in performing a wide range of activities and tasks.

Conventional AI agents operate through predefined algorithms and machine learning models that are trained on large datasets associated with the tasks that the AI agent is intended to handle. While the AI agents have demonstrated considerable success in performing specific tasks, such as natural language processing, image recognition, and recommendation systems, the AI agents often suffer from certain limitations and disadvantages.

One prominent drawback of conventional AI agents is their lack of contextual understanding and adaptability to changing environments. The AI agents typically operate within predefined boundaries and often do not comprehend nuances in language, user intent, or situational context. As a result, the AI agents can provide inaccurate responses or fail to adequately address user queries, leading to user frustration and dissatisfaction.

Furthermore, conventional AI agents often exhibit limited scalability and flexibility. As the complexity and diversity of tasks increase, the AI agents struggle to accommodate evolving user needs and preferences, thereby impeding their effectiveness and utility in real-world applications and environments.

Additionally, conventional AI agents are susceptible to biases and inaccuracies inherent in the training data used to train machine learning models that interact with the AI agents, leading to biased decision-making and unethical outcomes in certain scenarios. Moreover, the AI agents can raise concerns regarding user privacy and data security, particularly when handling sensitive information or personal data.

Furthermore, conventional systems have difficulty orchestrating or controlling multiple AI agents at the same time. The AI agents have limited or highly specific functionality, and if multiple decision paths or options are available to the agents, then they have difficulty deciding the proper decision or path, or how to select which path to route the information.

### SUMMARY OF THE INVENTION

In light of these challenges, there exists a need for improved systems and methods that enhance the functionality, adaptability, and performance of AI agents while mitigating the aforementioned limitations. The present invention addresses these needs by providing novel techniques for enhancing the intelligence, responsiveness, and reliability of AI agents in various applications, as further described herein.

The present invention is directed to an agent deployment system that monitors incoming data for selected trigger events, and then selecting a specific plurality or subset of AI agents to handle the trigger event. The agent deployment system can employ an agent subsystem that has a control agent that is fully trained on the playbooks of an enterprise. Once trained, the control agent can receive and monitor the incoming data for a trigger event. If a trigger event is detected, then the control agent selects a subset of AI agents that are specifically trained to handle the trigger event.

The present invention is also directed to the orchestration of a multi-agent end to end workflow sequence, where the system orchestrates the right set of AI agents, at the right time, and in the right sequence, to execute an end-to-end business workflow, and with control and governance agents to oversee and optimize the workflow.

The present invention is directed to a computer-implemented agent deployment system for adaptive management of a plurality of artificial intelligence (AI) agents within an enterprise computing environment of an enterprise. The system can include an agent subsystem having a control agent configured to: receive source data from one or more data sources of the enterprise, continuously monitor the source data for an occurrence of a trigger event indicative of a condition requiring an AI based intervention by the plurality of AI agents, detect the trigger event, evaluate the trigger event to identify a relevant operational context, and based on the trigger event and the operational context, select and deploy the plurality of AI agents from a total set of AI agents to address the trigger event by performing an AI-based intervention. The selected plurality of AI agents can be dynamically instantiated, activated, or reconfigured for event-specific processing. The system can also include a governance agent that is configured to manage a governance policy in a governance playbook of the enterprise.

The control agent can include a machine learning model that is trained on one or more playbooks of the enterprise so as to determine the existence of the trigger event related to the playbooks that requires the AI based intervention. The control agent can further include a self-assessment unit for evaluating the performance of the control agent during operation within the enterprise computing environment, a detection unit for applying a detection technique to the source data for detecting the trigger event in the source data, and an agent selection unit for selecting the plurality of agents based on the trigger event and the operational context. The control agent can still further include a characterization unit for applying a classification technique to the plurality of control agents for characterizing the AI agents into one of a plurality of categories. Each of the plurality of agents can include an agent machine learning model that is trained on training data that includes data associated with at least one of the playbooks of the enterprise or that includes actions and behaviors of a selected user. The governance agent can include a governance machine learning model that is trained on training data that includes data associated with the governance playbook of the enterprise.

The present invention is also directed to a computer-implemented method for adaptive management of a plurality of artificial intelligence (AI) agents within an enterprise computing environment of an enterprise. The method can include providing an agent subsystem having a control agent configured to: receive source data from one or more data sources of the enterprise, continuously monitor the source data for an occurrence of a trigger event indicative of a condition requiring an AI based intervention by the plurality of AI agents, detect the trigger event, evaluate the trigger event to identify a relevant operational context, and based on the trigger event and the operational context, select and deploy the plurality of AI agents from a total set of AI agents to address the trigger event by performing an AI-based intervention. The selected plurality of AI agents can be dynamically instantiated, activated, or reconfigured for event-specific processing. The method can further include providing a governance agent configured to manage a governance policy in a governance playbook of the enterprise.

The method of the present invention can further include configuring the control agent to include a machine learning model, and training the machine learning model on one or more playbooks of the enterprise so as to determine the existence of the trigger event related to the playbooks that requires the AI based intervention. The control agent can be further configured to evaluate the performance of the control agent with a self-assessment unit during operation within the enterprise computing environment, apply a detection technique to the source data with a detection unit for detecting the trigger event in the source data, and select the plurality of agents with an agent selection unit based on the trigger event and the operational context. Still further, the control agent can be configured to apply a classification technique to the plurality of control agents for characterizing the AI agents into one of a plurality of categories.

According to one embodiment, the plurality of agents can include an agent machine learning model trained on training data that includes data associated with at least one of the playbooks of the enterprise. Alternatively, the agent machine learning model can be trained on training data that includes actions and behaviors of a selected user. The governance agent can include a governance machine learning model trained on training data that includes data associated with the governance playbook of the enterprise.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of an agent deployment system according to the teachings of the present invention.

FIG. 2 is a schematic block diagram showing selected details of a control agent forming part of the agent deployment system of FIG. 1 according to the teachings of the present invention.

FIG. 3 is a schematic block diagram showing selected details of an AI agent selected by the control agent of the agent deployment system of FIG. 1 according to the teachings of the present invention.

FIG. 4 is a schematic block diagram of one example of the types of AI agents selected by the control agent when a selected type of trigger event is detected according to the teachings of the present invention.

### DETAILED DESCRIPTION OF THE INVENTION

The present invention is directed to a system for generating and deploying artificial intelligent agents that are trained to perform a selected series of tasks. The system of the present invention employs a command artificial intelligent (AI) agent that monitors incoming data for trigger events, and if a trigger event is detected, determines and selects a set of artificial intelligent agents that can be deployed to handle and address the trigger event.

The agent deployment system of the present invention relates generally to the field of artificial intelligence (AI) agents and associated systems, and more specifically to AI agent architecture and orchestration within enterprise computing environments. In particular, the agent deployment system of the present invention utilizes a control agent that monitors operational data within an enterprise for the occurrence of one or more defined or selected trigger events and, upon detection, dynamically selects and activates a set of AI agents to address the trigger event. The agent deployment system provides practical improvements to the functioning and deployment of AI agents in an enterprise environment by enabling responsive, context-driven agent selection, deployment, and engagement that is tailored to real-time enterprise needs based on detected trigger events.

Conventional AI agent systems used in enterprise environments often rely on statically configured agent assignments or scheduled agent tasks, which do not adapt effectively and efficiently to the changing conditions and demands of enterprise operations. These static configurations can result in incorrect agent assignment and deployment, misallocated computing resources, delayed reaction times to critical issues, and overprovisioning of agents regardless of necessity. The agent deployment system of the present invention overcomes these deficiencies by introducing a control agent capable of continuously or periodically monitoring enterprise-level signals or data, such as system events, transaction logs, telemetry streams, user activity, sensor inputs, and the like, so as to identify when a specific operational condition, anomaly, or external event meets the criteria for agent selection, deployment, and intervention.

Upon identifying such a trigger event, the control agent can be configured to dynamically evaluate the context and selectively deploy a subset of AI agents from a larger or total set of agents that are configured or optimized to address or handle the trigger event. The agent selection and deployment can involve initiating new agent instances, activating dormant agents, selecting agents, or reallocating agents already in operation. The control agent can further incorporate enterprise playbooks or policies, historical context, or real-time performance data to ensure that the most suitable agents are selected. In doing so, the agent deployment system facilitates an intelligent and adaptive approach to AI agent selection and management, and specifically an approach that aligns computational actions with actual enterprise demands and conditions.

The agent deployment system of the present invention is rooted in a specific and concrete technological implementation involving defined computing components operating in coordination to address a technical challenge in enterprise computing. The agent deployment system does not merely automate a human decision-making process, nor is it directed to a generic abstract idea. Rather, the agent deployment system improves how systems employing AI agents function in practice by optimizing agent selection, deployment, and coordination, thereby ensuring real-time adaptability and increasing operational responsiveness in complex computing environments.

In addition to enhancing system adaptability, the agent deployment system improves the computational efficiency across the enterprise environment. By eliminating the need for all AI agents to be persistently active or redundantly monitoring the system, the invention conserves processing power, memory, and network bandwidth by employing a control agent and selected agents best configured to handle the trigger event. The control agent's centralized monitoring role ensures that computationally intensive AI tasks are only executed in response to qualifying trigger events, thereby reducing unnecessary background computation and idling resource usage. This event-driven architecture allows for intelligent throttling and scaling of AI agent workloads, enabling more efficient use of computing infrastructure without sacrificing responsiveness or functionality.

Further, because the AI agent selection is context-sensitive and targeted, the agent deployment system avoids the inefficiency of broad or misaligned agent activation. Instead, the system directs resources toward only those agents that are appropriate for the specific trigger event, further minimizing processing overhead and optimizing throughput. These operational gains translate into measurable improvements in computing utilization, response latency, and overall system performance in real-world enterprise settings. Thus, the agent deployment system of the present invention delivers a technical solution to a technical problem, namely, how to dynamically manage distributed AI agent workloads in a way that is both responsive to trigger events and resource-efficient, through a structured and technologically grounded agent orchestration framework.

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “source data” can include any type of data from any suitable source that would benefit from being converted into a more usable form or should be acted upon by the system of the present invention. The sources can include for example data warehouses, data lakes, data stores, and the like. The source data can include, for example, financial related data and non-financial related data. As used herein the term “financial data” can include any data that is associated with or contains financial or financial related information. The financial information can include information that is presented free form or in tabular formats and is related to data associated with financial, monetary, or pecuniary interests. Further, as used herein, the term “non-financial data” is intended to include all data, including if appropriate environmental data, that is not financial data as defined herein, and can include for example biometric data. The source data can be in hard copy or written form, such as in printed documents, or can be in digital file formats, such as in portable document format (PDFs), word processing file formats such as WORD documents, as well as other file formats including hypertext markup language (HTML) file formats and the like. It is well known in the art that the hard copies can be digitized, and the relevant data extracted therefrom.

As used herein, the term “enrich,” “enriched” or “enriching” is intended to include the ability to ingest, integrate, augment, improve and/or enhance data by supplementing missing or incomplete data, correcting inaccurate data, adding additional data, or processing the data using known techniques, such as with artificial intelligence, machine learning and risk modelling techniques, and then applying logic and structure to the data so as to curate, correct and/or clean the data. The term enrich can also include the ability to correlate factors to the data so as to generate or create meaningful insights and conclusions based on the data, including environmental and financial data. In the context of prompts, the prompts can be enriched by adding more context, detail, or specificity in order to better guide or instruct a machine learning model a conversation or direct the output of the model towards a desired outcome. This can involve providing additional information, constraints, examples, or specifications that help the model generate a more relevant and tailored response.

As used herein, the term “machine learning” or “machine learning model” or “model”, whether in singular or plural form, is intended to mean or refer to the application of one or more software application based techniques that process and analyze data to identify patterns and to generate inferences, predictions, classifications, decisions, and/or recommendations based on the patterns in the data. The machine learning techniques may include a variety of models and algorithms, such as supervised learning, unsupervised learning, reinforcement learning, semi-supervised learning, deep learning, and natural language processing (NLP) techniques, including natural language generation (NLG) and generative language models. The machine learning models are typically trained using training data. The training data is used to optimize the parameters of the model, such as the weights in a neural network. As such, the better the training data, the more accurate and effective the machine learning model can be. In the case of supervised learning, the training data includes labeled examples (i.e., input-output pairs) that allow the model to learn a mapping from inputs to target outputs. Common tasks performed by supervised learning models include classification and regression. Unsupervised learning models are trained on unlabeled data and are configured to identify hidden patterns, structures, or groupings in the data. Common unsupervised learning tasks include clustering and dimensionality reduction. Semi-supervised learning techniques combine elements of supervised and unsupervised learning by utilizing a small amount of labeled data in conjunction with a larger volume of unlabeled data to improve model performance. The semi-supervised learning models combine elements of both supervised and unsupervised learning models, utilizing limited labeled data alongside larger amounts of unlabeled data to improve model performance. Reinforcement learning involves training an agent to take sequential actions within an environment to maximize a reward signal. The agent learns through trial and error by receiving feedback in the form of rewards or penalties based on its actions. Deep learning is a subfield of machine learning that utilizes neural networks with multiple layers to automatically learn hierarchical feature representations from data. A neural network includes a plurality of interconnected nodes (or “neurons”) organized into layers, where each connection is associated with a weight that determines the strength of the signal passed between neurons. The weights are updated during training to minimize prediction error and improve performance. By adjusting these weights based on input data and desired outcomes, neural networks can learn complex patterns and relationships within the data. Examples of neural networks used in deep learning include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), and transformer-based architectures. Transformer-based models, including large language models (LLMs), are configured to process and generate human language by learning contextual relationships between tokens in a sequence. These models are typically pre-trained on large corpora of text using self-supervised learning techniques and can perform a wide range of language-related tasks, such as text generation, translation, summarization, question answering, and sentiment analysis. The large language models (LLMs) may include, or be implemented as, generative artificial intelligence (AI) models that are capable of generating coherent and contextually appropriate text responses based on input prompts. LLMs can be configured to understand and generate human language by learning patterns and relationships from large datasets. These models may utilize deep learning techniques, particularly transformer architectures, to process and generate text. LLMs can be pre-trained on massive corpora of textual data using self-supervised learning techniques and may perform tasks such as text generation, language translation, summarization, sentiment analysis, question answering, and other natural language processing tasks.

A transfer learning model can involve training a model on a first task and subsequently applying the learned parameters or representations to a second, related task, thereby enhancing training efficiency and model performance. An ensemble learning model can combine the outputs of multiple individual models to improve overall predictive accuracy. Common ensemble techniques include bagging, boosting, and stacking. An online learning model can be incrementally updated as new data becomes available, making such models suitable for real-time or dynamic environments. An instance-based learning model can generate predictions based on similarity measures between new input instances and previously observed training instances.

The machine-learning processes described herein may be utilized to generate machine-learning models. As used herein, a machine-learning model refers to a mathematical representation of a relationship between one or more inputs and corresponding outputs, generated using any machine-learning technique, including without limitation any of the processes described above, and stored in memory. Once created, a machine-learning model may receive one or more input values and produce a corresponding output based on the learned relationship derived during training. For example, and without limitation, a linear regression model generated using a linear regression algorithm may compute a linear combination of input features using coefficients learned during training to generate an output value. As a further non-limiting example, a machine-learning model may be implemented as an artificial neural network, such as a convolutional neural network (CNN), comprising an input layer of nodes, one or more hidden (intermediate) layers, and an output layer of nodes. Connections between nodes may be established and weighted through a training process in which data from a training dataset are applied to the input layer. A training algorithm-such as Levenberg-Marquardt, conjugate gradient, simulated annealing, or other optimization algorithms—may be used to iteratively adjust the connection weights between nodes in adjacent layers to minimize prediction error and produce desired outputs at the output layer. This type of approach may be referred to as deep learning.

As used herein, the term “generative model,” “generative AI model” or “generative language model”, whether in singular or plural form, is intended to mean or refer to a category of machine learning models configured to generate new outputs based on data on which the models have been trained. Generative models may produce new content in various modalities, including text, images, audio, code, simulations, and the like. Generative language models specifically focus on generating natural language text and are typically based on deep learning neural networks, such as large language models (LLMs) employing transformer architectures. These models learn patterns and relationships within training data and generate new language content based on the learned representations. Generative models may include, without limitation, generative adversarial networks (GANs), which consist of two neural networks trained adversarially to generate realistic images, audio, or other data types; variational autoencoders (VAEs), which learn latent representations of data for generation tasks; and deep convolutional GANs (DCGANs), which use convolutional layers for generating realistic images and textures. For language generation tasks, recurrent neural networks (RNNs), including variants such as long short-term memory (LSTM) networks and gated recurrent units (GRUs), have historically been employed to generate sequential data by predicting the likelihood of each word based on preceding context. More recently, transformer-based architectures have become prevalent for natural language processing and generation, as they can effectively attend to various parts of input sequences and learn complex dependencies to produce coherent and contextually relevant text. The generative AI models described herein can be trained on diverse types of training data, including text, images, and audio, and can be applied to a variety of applications such as image and video synthesis, natural language generation, music composition, code generation, and other content creation tasks.

In the present disclosure, data used to train a machine learning model can include data containing correlations that a machine learning process or technique may utilize to model relationships between two or more types or categories of data elements (“training data”). For example, and without limitation, the training data may comprise a plurality of data entries, each entry representing a set of data elements that were recorded, received, and/or generated together. The data elements may be correlated by shared co-occurrence within a data entry, proximity within the data, or other relationships. Multiple data entries within the training data may exhibit one or more trends or patterns in correlations between categories or types of data elements. For instance, and without limitation, a higher value of a first data element belonging to a first category or type of data element may tend to correlate with a higher value of a second data element belonging to a second category or type of data element, indicating a possible proportional or other mathematical relationship linking values across categories. Multiple categories of data elements may be related in the training data according to various correlations, which may indicate causative, associative, and/or predictive links between categories of data elements. These correlations may be modeled as mathematical or statistical relationships by the machine learning processes described herein. The training data may be formatted and/or organized by categories of data elements, for example by associating data elements with one or more descriptors corresponding to categories. As a non-limiting example, training data may include data entered in standardized forms by persons or processes, such that entry of a given data element in a given field within a form may be mapped or correlated to one or more category descriptors. Elements in the training data may be linked to descriptors of categories or types by tags, tokens, or other data elements. For example, and without limitation, training data may be provided in fixed-length formats, formats linking positions of data to categories such as comma-separated value (CSV) formats, and/or self-describing formats such as extensible markup language (XML), enabling processes or devices to detect categories of data.

Alternatively, or additionally, the training data may include one or more data elements that are not categorized, that is, the training data may not be formatted or contain descriptors for some elements of data. Machine-learning models or algorithms and/or other processes may sort the training data according to one or more categorizations using, for instance, natural language processing algorithms, tokenization, detection of correlated values in raw data and the like. The categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name or other types of data may be identified by reference to a list, dictionary, or other compendium of terms, permitting ad-hoc categorization by machine-learning algorithms, and/or automated association of data in the data entry with descriptors or into a given format. The ability to categorize data entries automatically may enable the same training data to be made applicable for two or more distinct machine-learning algorithms as described in further detail below. Training data used by an electronic device may correlate any input data as described in this disclosure to any output data as described in this disclosure.

As used herein, the terms “AI agent,” “artificial intelligence agent,” or simply “agent” refer to a software-based system or program configured to perceive information from one or more environments, interpret or analyze such information, make determinations or decisions based thereon, and perform actions in an autonomous or semi-autonomous manner to achieve one or more defined objectives. The AI agent can incorporate or interface with one or more machine learning models, such as generative language models, neural networks, decision trees, or other statistical or computational methods, that are configured to process input data, identify patterns, and generate outputs or predictions based on learned representations. In various embodiments, the AI agent is further capable of adapting its behavior over time through one or more learning processes that do not require explicit reprogramming. Such learning processes may include supervised learning based on labeled training data, reinforcement learning in which the agent receives feedback (e.g., rewards or penalties) in response to its actions, or unsupervised learning in which the agent autonomously identifies structures or patterns within unlabeled data. The agent can thereby improve its performance, accuracy, or decision-making capabilities through iterative interaction with data and the surrounding environment. In some embodiments, the AI agent can operate within a feedback loop, wherein the agent's actions influence the environment, and the resulting environmental response provides additional input or feedback used to refine subsequent behavior or decisions by the agent. The AI agent may further be configured to interact with one or more human users, external systems, or other agents, either cooperatively or competitively, depending on the operational context. The design and implementation of the AI agent can vary by application, but generally encompass components for perception, inference, decision-making, action execution, and learning, each of which may be implemented using modular software components or computational architectures.

As used herein, the term “playbook”, whether in singular or in plural form, refers to one or more structured documents, frameworks, or data objects that define predefined strategies, workflows, decision paths, and/or best practices for addressing specific tasks, events (e.g., trigger events), or operational challenges, within an enterprise environment, such as an enterprise computing environment. The playbook can include formalized guidance for business processes, technical procedures, incident response protocols, stakeholder responsibilities, compliance rules, and domain-specific methodologies. Each playbook can be associated with one or more use cases or scenarios, and can specify multi-stage workflows including, for example, initiation, planning and design, execution, review and approval, communication, completion, and evaluation stages. Playbooks can be authored by human stakeholders or generated, updated, or optimized by Ai resources, such as AI agents, based on learned experience, historical performance data, human-agent interaction patterns, and the like. Examples of enterprise playbooks can include, for example, incident response playbooks, information technology (IT) operations playbooks, business continuity playbooks, sales and marketing playbooks, compliance and governance playbooks, onboarding guides, customer service protocols, and the like. Playbooks can be dynamic in nature, subject to revision and continuous learning, and may serve as training tools or execution guides for both human users and AI agents within the enterprise computing environment. The playbooks can also be directed to response plans for handling emergencies, crises, or unforeseen events that can disrupt or impact enterprise operations. The response plans outline predefined actions to mitigate risks, minimize impacts, and ensure business continuity. The playbook can be singular documents or can be a combination of related playbooks. The playbooks can also be generated by the AI agents such that the agents create their own playbooks based on the learnings from human interactions and interactions with other agents. Further, the Ai agents can be configured to recommend updates or can optimize existing playbooks.

As used herein, the term “data object” can refer to a location or region of storage that contains a collection of attributes or groups of values that function as an aspect, characteristic, quality, entity, or descriptor of the data object. As such, a data object can be a collection of one or more data points that create meaning as a whole. One example of a data object is a data table, but a data object can also be data arrays, pointers, records, files, sets, and scalar type of data.

As used herein, the term “attribute” or “data attribute” is generally intended to mean or refer to the characteristic, properties or data that describes as aspect of a data object or other data. The attribute can hence refer to a quality or characteristic that defines a person, group, or data objects. The properties can define the type of data entity. The attributes can include a naming attribute, a descriptive attribute, and/or a referential attribute. The naming attribute can name an instance of a data object. The descriptive attribute can be used to describe the characteristics or features or the relationship with the data object. The referential attribute can be used to formalize binary and associative relationships and in referring to another instance of the attribute or data object stored at another location (e.g., in another table). When used in connection with prompts for use with a generative language model, the term is further defined below.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “electronic device” can include servers, controllers, processors, computers, tablets, storage devices, databases, memory elements and the like.

The agent deployment system of the present invention can be configured for adaptive management of artificial intelligence (AI) resources, such as AI agents, within an enterprise computing environment. The system can include an agent subsystem having a control agent configured to receive source data from one or more enterprise data sources, continuously monitor the source data for the occurrence of trigger event data indicative of a condition requiring AI-based intervention, evaluate the trigger event data to identify a relevant operational context, and based on the trigger event data and the operational context, select and deploy a first plurality of AI agents from a total set of AI agents to address the trigger event data. The selected AI agents can be dynamically instantiated, activated, or reconfigured for event-specific processing. The system can also include a governance agent configured to manage governance policies associated with agent activation, data access, and AI task execution in accordance with enterprise-defined rules and policies.

As used herein, the term “AI resource”, whether in singular or in plural form, refers to artificial intelligence (AI) components or functionalities, including for example AI agents, machine learning models, algorithms, and/or services, that are capable of performing computational tasks involving data analysis, inference, prediction, decision-making, or other forms of automated reasoning. The resources can be configured to operate autonomously or semi-autonomously in order to support, augment, or replace human decision-making processes within enterprise workflows.

As used herein, the term “enterprise computing environment”, whether in singular or in plural for, refers to a computing infrastructure that supports the digital operations, data flows, and information systems of an enterprise. Such environments can include, for example, electronic devices, distributed computing platforms, cloud-based systems, on-premises servers, edge devices, computing devices, data storage systems, communication networks, associated software applications and components, and the like, which can be configured to interact with internal and external data sources and to support enterprise-level applications, processes, and services.

As used herein, the term “AI-based intervention”, whether in singular or in plural form, refers to an automated or semi-automated action performed by one or more AI resources in response to a detected condition, such as a trigger event. Such interventions can include, by simple way of example, initiating a diagnostic process or security procedure, generating a prediction, issuing a recommendation, performing automated classification, launching a remediation task, or executing other forms of intelligent processing to address, mitigate, or respond to a detected operational issue or threat within the enterprise computing environment.

As used herein, the term “operational context” refers to the set of environmental, temporal, technical, and situational conditions, circumstances, or parameters present at or surrounding the time of occurrence of a trigger event within an enterprise computing environment. The operational context can include, fore example, data relating to system state, infrastructure status, workload levels, user activity, application usage patterns, temporal or geographic metadata, historical trends, and external dependencies. In some embodiments, the operational context may further include references to applicable enterprise playbooks that define expected procedures or workflows associated with the given event or scenario. The operational context is used by the agent deployment system to assess the nature and importance of the trigger event, to select relevant AI resources (e.g., AI agents) for response, and to tailor agent behavior (e.g., instantiation, configuration, or execution parameters) based on context-aware factors, such as operational context. By incorporating the operational context, including applicable playbooks, the system enables dynamic, situation-specific decision-making aligned with enterprise objectives and governance constraints.

As used herein, the term “event-specific processing” can refer to computational operations performed by one or more AI agents that are tailored to the particular characteristics, requirements, and context of a detected trigger event. Such processing can involve dynamically adjusting the behavior, parameters, or structure of the AI agents in order to deliver a targeted, effective response aligned with the operational objectives of the enterprise.

As used herein, the term “AI task execution” refers to the performance of a designated computational task by an AI resource, such as a task involving data ingestion, pattern recognition, prediction generation, anomaly detection, optimization, classification, or another function requiring the application of one or more machine learning techniques. Execution of such tasks may occur in real time or batch mode and may be subject to enterprise-defined constraints, workflows, or governance policies.

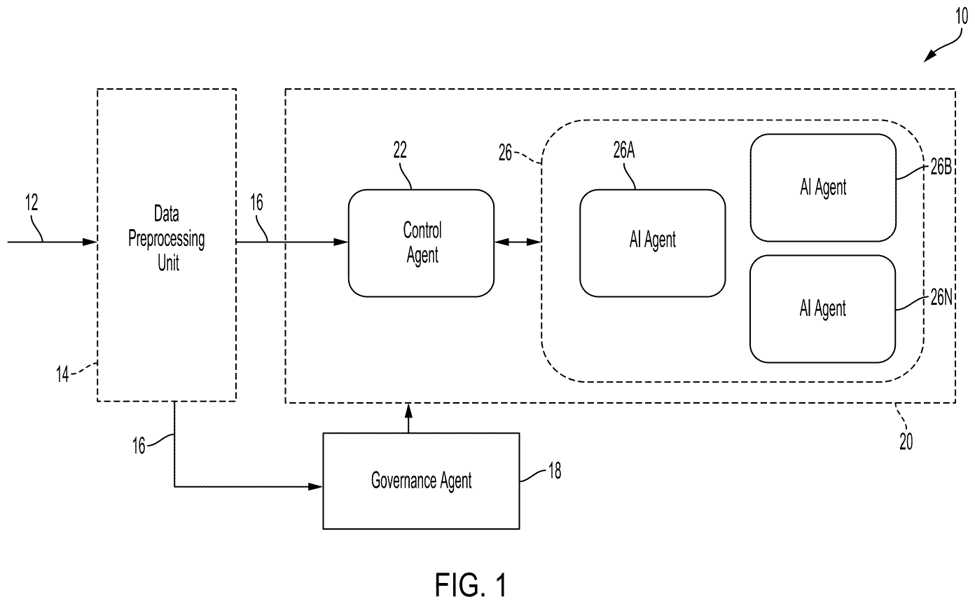

The present invention is directed to a system for selecting, deploying and utilizing an AI resource, such as artificial intelligent (AI) agents, in a select environment, such as in an enterprise computing environment. One example of the agent deployment system of the present invention is shown for example in FIG. 1. The illustrated agent deployment system 10 receives source data 12 from a number of different types of data sources that are representative of a number of different types of data with an enterprise. The source data 12 can include any type of data, including for example financial data, non-financial data, business process data, security data, threat mitigation data, and the like. The source data 12 can be conveyed directly to an agent subsystem 20 or can be preprocessed by an optional data preprocessing unit 14. The source data 12 can be conveyed through any suitable data connection, such as via a network. The data preprocessing unit 14 can optionally preprocess the source data 12 by cleaning and enriching the data for subsequent use by the agent subsystem 20 in a variety of different ways. For example, the data preprocessing unit 14 can be configured to initially extract the source data 12 by utilizing an extract, transform and load (ETL) technique. The data preprocessing unit 14 can be configured during the extraction process to copy the data from the data sources, transform the data by converting the data into another usable form or suitable format, and then load the data if needed into a suitable data storage unit. The data preprocessing unit 14 can thus serve as one or more extract, transform and load (ETL) data pipelines between the data sources of the source data 12 and the data storage unit of the data preprocessing unit 14. The data storage unit can be in essence a data lake or a data warehouse. As such, the data storage unit can be configured to store the extracted data in a raw data format, usually as object blobs or files. The data storage unit can also be configured to store processed data in addition to the raw data 12. The data preprocessing unit 14 can be configured to preprocess and enrich the data for subsequent use by agent subsystem 20. Specifically, the data preprocessing unit 14 can be configured to pull the extracted data stored in the data storage unit and then perform a series of preprocessing and enrichment operations on the data. The data storage unit can form part of the data preprocessing unit 14 or can be a separate component of the agent deployment system 10.

The data preprocessing unit 14 can also be configured to clean the data. As used herein, the terms “data cleaning,” “cleaning,” and “clean” include the process of detecting and correcting or removing corrupt, inaccurate, or duplicate records from data, such as for example from a record set, table, or database by identifying incomplete, incorrect, inaccurate or irrelevant parts of the data and then replacing, modifying, or deleting the raw, dirty or coarse data. Once the data is cleaned by the data preprocessing unit 14, the cleaned data is consistent with other similar data or data sets in the agent deployment system 10. The data inconsistencies detected or removed by the data preprocessing unit 14 can be originally caused by user entry errors, by corruption in transmission or storage, or by different data dictionary definitions of similar entities located in different data stores. The cleaned data generated by the data preprocessing unit 14 can also optionally be used as data to populate a common data model to provide a comprehensive data framework and common interface for the preprocessed data. For example, the data preprocessing unit 14 can further include or employ a common data model that incorporates or includes the cleaned data. The common data model can serve to conform, organize, and normalize elements of data and standardize or normalize how the data elements relate to one another and to the properties of real-world entities. As is known, data models can include a set of standardized, extensible data schemas that employ a defined set of data entities, data attributes, relationships, and semantic metadata (i.e., traits). The data entity can describe the structural shape and semantic meaning for records of the data. The entities can thus represent physical objects, locations, interactions, individuals, point-in-time measurements, data types, and the like. The entity can also describe the meaning and shape of the data through a set of attributes, which can include an atomic or simple attribute type and a more complex, composite attribute type. The common data model allows downstream applications to be able to use the data stored therein by providing a common, normalized, standardized, and shared data language for the applications to use. The common data model of the present invention can utilize the entities in the Microsoft common data model, and can further include other types of entities, such as playbook data. The data preprocessing unit 14 can thus generate preprocessed data 16 if utilized by the system 10.

The source data 12 or the preprocessed data 16 can be conveyed to an agent subsystem 20. The agent subsystem 20 can include a control agent 22 and a plurality of agents 26. The agent subsystem 20 can be configured to instantiate (e.g., create or generate), activate, or reconfigure a plurality of agents or can be configured to select (e.g., activate) and deploy a plurality of previously generated agents. The selected agents can form a subset of a larger set of agents. The larger set of agents can be the total set of agents employed by the enterprise or less than the total set of agents. The agent subsystem 20 can include a control agent 22 and a plurality of selected agents 26 from a larger set of agents. The control agent 22 and the agents 26 can be AI agents. The control agent 22 can serve as a managing agent that receives the data 12, 16 and monitors the data for trigger event data. Based on the type of trigger event data, the control agent 22 can then select and deploy a plurality of agents 26 from the larger or total set of agents that are needed to perform an AI-based intervention, such as by responding to or acting upon the trigger event data. As used herein, the term “trigger event”, whether in singular or in plural form, refers to a detectable condition, occurrence, or pattern derived from monitoring one or more enterprise data sources 12, which is indicative of a situation warranting automated or semi-automated analysis, intervention, or decision-making using one or more AI agents. The data can encompass various forms of data, including for example textual data, numerical data, visual data, auditory data, or contextual data. Trigger events initiate the evaluation and activation process within the agent deployment system and are used to determine when, and in what context, AI resources should be selectively instantiated, activated, or reconfigured and subsequently selected and deployed. Examples of trigger events may include detection of anomalous network traffic patterns indicating or suggestive of a cybersecurity threat, performance degradation in enterprise applications, violation of service level thresholds such as those related to latency, availability, or throughput, unusual transaction activity that may suggest or be indicative of fraud or noncompliance issues, environmental alerts from sensors (e.g., temperature or humidity sensors), operational status changes including unexpected server outages or system restarts, user access events that are inconsistent with established behavioral baselines such as after-hours access to sensitive systems or data repositories, sales and marketing activities or operations, or any other type of activity within the enterprise that benefits from automation or semi-automation. The agent deployment system continuously monitors for such trigger events in real time and, upon detection, evaluates the surrounding operational context to enable targeted and context-aware selection and orchestration of AI agents in accordance with enterprise objectives. The data can originate from internal sources within the enterprise, external sensors, databases, application programming interfaces (APIs), user interactions, or any other relevant data source. The efficacy of the trigger event data is correlated to the ability of the data to accurately reflect conditions or circumstances warranting action by one or more AI agents, thus facilitating timely and appropriate responses (e.g., AI based intervention) to dynamic environmental conditions or user needs.

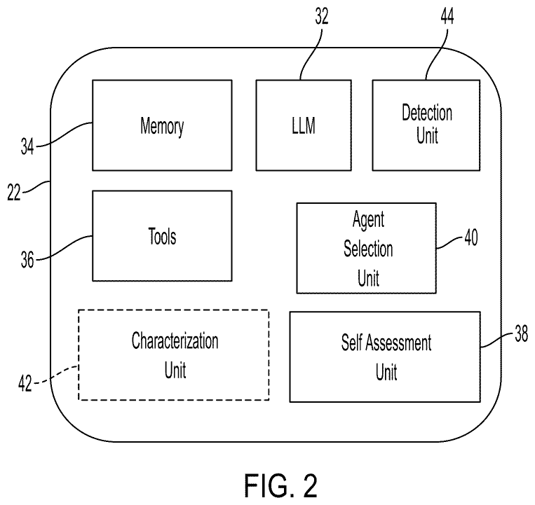

An example of a suitable control agent 22 is shown, for example, in FIG. 2. The illustrated control agent 22 can employ, invoke or integrate a generative language model 32, such as a large language model, that can be trained on specific types of data. According to one embodiment, the control agent 22 can be trained on training data that includes some or all of the playbook data associated with the enterprise. For example, the control agent 22 can be trained on the various playbooks of the enterprise, such that the control agent 22 can determine or detect the existence of a trigger event associated with one or more of the playbooks that needs to be addressed. The playbook data can be optionally cleaned and processed to remove errors, inconsistencies, and irrelevant information. This can involve tasks such as normalization, scaling, feature extraction, and handling missing values. The hyperparameters of the generative language model can be configured based on the playbook data, and the hyperparameters can include, for example, learning rate, batch size, and optimization algorithms. Optionally, the trained model can be validated on a separate validation dataset to assess the overall accuracy of the trained model and the hyperparameters can be further fine-tuned if necessary. The training of the model can be iteratively done, adjusting the model architecture, hyperparameters, or training data as needed to improve model performance. Further, the trained model can be fine-tuned based on insights gained from validation and evaluation results. The performance of the trained model can be monitored and maintained by collecting feedback and updating the model as necessary to adapt to changing data distributions or requirements. Regular maintenance and retraining of the model may be required to ensure that the AI agent remains effective over time. Alternatively, the maintenance and retraining can be ongoing.

The control agent 22 can also include a memory 34 for storing selected data, including for example decision log information, past experiences, decisions, observations, and interactions. By retaining knowledge gained from previous encounters, the control agent 22 can learn from previous mistakes or interactions, refine overall strategies, and improve its performance over time. The control agent 22 can also include a tools sub-unit 36 that can serve as a repository of various computational resources, algorithms, and utilities designed to support the function of the agent, enhance its capabilities, and facilitate operational efficiency. For example, the tools sub-unit 36 can house a diverse range of algorithms and computational techniques that are essential for performing various tasks, such as data processing, analysis, pattern recognition, optimization, and decision-making. The algorithms can include for example machine learning models, statistical methods, natural language processing (NLP) tools, computer vision algorithms, and the like. The tools sub-unit 36 can also provide tools and utilities for preprocessing, cleaning, transforming, and augmenting data before feeding the data to the agent for training or inference. Data processing tasks can include, for example, feature extraction, dimensionality reduction, normalization, and data integration.

Further, the control agent 22 can include a self-assessment unit 38 that allows the agent to evaluate or self-assess its own performance, capabilities, and operational and functional state. The self-assessment unit 38 serves to enhance the agent's autonomy, self-awareness, and ability to adapt to changing environmental conditions. Specifically, the self-assessment unit 38 evaluates the agent's performance across different tasks, domains, or contexts, monitors key performance metrics, such as accuracy, precision, recall, F1-score, or task-specific metrics, and assesses how well the agent is accomplishing any stated objectives. The self-assessment unit 38 ensures the quality and reliability of the AI agent's outputs and actions by detecting and flagging potential errors, inconsistencies, or deviations from expected behavior. According to one embodiment, the self-assessment unit 38 can be configured to assess a confidence level of the predictions or decisions of the agent. The self-assessment unit 38 can calculate or determine a confidence or assessment score associated with each prediction, thereby allowing the agent to express uncertainty and make informed decisions based on the degree of confidence in the outputs generated thereby. The self-assessment unit 38 can also facilitate dynamic adaptive learning by monitoring the performance of the agent over time and identify areas for improvement or refinement. The dynamic adaptive learning can be accomplished by analyzing patterns of success and failure, gather feedback from interactions, and adjust the agent's behavior or strategies accordingly to enhance the overall effectiveness of the agent.

The illustrated control agent 22 can also include an agent selection unit 40 configured to select one or more agents 26 from a larger or total set of agents, or to instantiate or reconfigure one or more agents 26 for deployment based on the trigger event data. The total or relatively complete set of agents can be predefined or preconfigured during, for example, system initialization, or can be dynamically generated in real time (e.g., instantiated), or derived using a combination of static and dynamic agent provisioning. The control agent 22 can be configured to monitor the input source data, such as the source data 12 or the preprocessed data 16, for the presence of trigger event data. To facilitate this, the control agent 22 can include a detection unit 44 for detecting the trigger event. The detection unit 44 can be configured to detect data patterns, conditions, or occurrences indicative of a trigger event, and can employ various detection techniques including, by way of example, rule-based analysis techniques (e.g., Boolean rules); threshold-based monitoring techniques; statistical anomaly detection techniques such as standard deviation analysis, z-score analysis, or probability density estimation techniques that are used to identify data points or behaviors that deviate significantly from a known distribution or baseline pattern; pattern recognition techniques such as using signal processing or time-series analysis techniques (e.g., Fourier transforms, wavelet analysis, or moving average convergence divergence (MACD)) to detect recurring sequences, trends, or temporal structures within the data; machine learning model-based classification techniques such as supervised learning techniques (e.g., decision trees, support vector machines, random forests, or neural networks) trained on labeled historical data to classify new inputs as belonging to one or more categories indicative of normal or abnormal conditions; or semantic inference techniques using a machine learning model, such as a generative language model (e.g., a large language model), to semantically interpret unstructured or semi-structured text inputs, extract intent, infer relationships, or detect contextually relevant patterns. The particular detection technique can be selected based on the characteristics of the data source and source data 12 and the operational objectives of the enterprise environment.

Upon detection of the trigger event by the detection unit 44, the agent selection unit 40 can evaluate the operational context, which can include, by simple way of example, system state, workload conditions, metadata, historical trends, references to enterprise playbooks, and the like, to determine which AI agents are best suited to respond to the trigger event in the operational context and to perform an AI based intervention. The agent selection can include identifying and deploying existing agents, instantiating new agents tailored to the event, or reconfiguring the parameters, objectives, or capabilities of one or more existing agents to optimize performance relative to the detected condition or trigger event. In some embodiments, the control agent 22 can also include an optional characterization unit 42 configured to categorize or organize the AI agents 26 into defined groups or categories based on one or more shared attributes or roles. Such categorization may be performed using classification techniques including rule-based assignment, unsupervised clustering, hierarchical taxonomy mapping, or embedding-based similarity scoring. Categorization or classification may be informed by metadata, performance history, or learned embeddings that represent agent functionality and specialization. Example categories of AI agents can include, for example and for illustration purposes, task-specific agents (e.g., agents configured for anomaly detection, summarization, or root cause analysis), domain-specific agents (e.g., financial, cybersecurity, or logistics-focused agents), modality-specific agents (e.g., text, image, or multimodal processing agents), autonomy-level agents (e.g., fully autonomous agents versus human-in-the-loop agents), role-based agents (e.g., initiators versus responders), lifecycle-stage agents (e.g., monitoring, diagnosis, resolution, and post-incident evaluation), and the like. Categorized agents may be further associated with corresponding enterprise playbooks to ensure alignment with predefined workflows, business rules, and governance protocols. The ability of the control agent 22 to detect relevant events, assess contextual information, and dynamically select, instantiate, or adapt AI agents enables the system to deliver context-sensitive, policy-aligned responses across a broad range of enterprise computing scenarios.

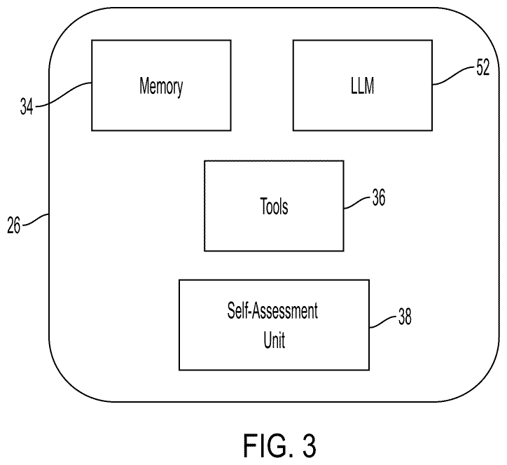

The AI agents 26 can be generated or created by the agent subsystem 20 of the enterprise and/or by employees of the enterprise. According to one example embodiment, each agent 26 can correspond to a selected playbook or employee of the enterprise. Specifically, each of the AI agents 26 can be trained on one or more playbooks of the enterprise. An example of the AI agents 26 is shown for example in FIG. 3, where like reference numerals indicate like parts. The illustrated AI agent 26 includes a memory 34, a tools unit 36 and a self-assessment unit 38. The AI agent 26 can also include a generative language model 52, such as a large language model, that can be trained on specific types of data. According to one embodiment, the generative language model 52 can be trained on training data that includes data associated with at least one of the playbooks of the enterprise, and if no playbook data is available or associated with the specific AI agent, then the AI agent can be trained on the actions and behaviors of a user. Once trained, the AI agent 22 can respond to specific detected trigger events in the enterprise. The playbook data can be optionally cleaned and processed to remove errors, inconsistencies, and irrelevant information. The hyperparameters of the generative language model 52, such as learning rate, batch size, and optimization algorithms, can be configured based on the characteristics of the playbook data. Optionally, the trained model can be validated on a separate validation dataset to assess the overall accuracy of the trained model and the hyperparameters can be further adjusted as needed. The training of the model can be iteratively done, adjusting the model architecture, hyperparameters, or training data as needed to improve model performance. After training, the model can be fine-tuned based on validation outcomes, and the model performance monitored over time. Feedback can be used to update and adapt the model to evolving data distributions or enterprise requirements. Additionally, the agent subsystem 20 can generate AI agents 26 that correspond to selected employees. In such cases, the employee may supply data for training the generative language model 52, and may specify an autonomy level that governs how independently the AI agent 26 operates. The autonomy level allows the employee to determine the degree of control or oversight retained over the agent's behavior.

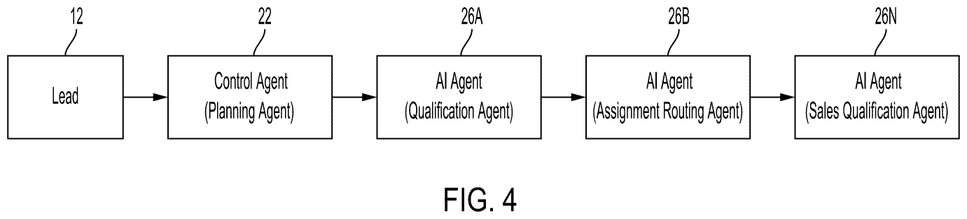

One example of the use of the agent deployment system 10 of the present invention is shown in FIG. 4. In the current illustrative example, the control agent 22 is trained on one or more playbooks of the enterprise and the agent selection unit 40 selects agents associated with sales and sales lead management. The source data 12 can include trigger event data, such as data related to sales leads. The control agent 22 can be configured to detect the trigger event data (e.g., lead data) with the detection unit 44, and then the agent selection unit 40 of the control agent 22, in response to the detected trigger event data, selects the agents 26A, 26B and 26N that are appropriate to respond to or handle the trigger event. In the current illustrative example, the AI agent 26A can be previously trained on the playbook associated with sales lead qualifications. The source data 12, including the trigger event data, is received by the AI agent 26A and the agent can act autonomously to process the data and generate a qualification score associated with the lead. The qualification score and associated lead data can then be received and processed by the AI agent 26B. The AI agent 26B can be trained on sales lead and the sales team member related playbook, and can analyze the qualification score and lead data, and if the qualification score is above a selected threshold level, the AI agent 26B can forward the lead data to an appropriate, or most appropriate, sales team member. The lead data is then received and processed by the AI agent 26N. The AI agent 26N can be trained on a playbook that assists the sales team member with contextual data associated with the lead data, so as to enable the sales team member to better assess and qualify the sales lead.

The decisions being generated by the agents 22, 26 can be monitored, tracked, and logged in the agent deployment system 10. According to one embodiment, the decisions can be stored in the memory 34 of the agent. The selection and deployment of the agents 26 enable the agent subsystem 20 to autonomously sense when action is needed, and then generate decisions and navigate employees through the business process. The AI agents 26 can be configured to connect with employees or stakeholders associated with the trigger event so as to seek information and to alert or advise the employee of the process being undertaken by the AI agents 26.

With reference again to FIG. 1, the agent deployment system 10 can also include a governance agent 18 for assisting the enterprise in administering, monitoring, and/or managing the governance objectives or policies of the enterprise. As used herein, the term “governance” or “governance policy”, whether in singular or plural form, and as it relates to the enterprise, refers to the frameworks, processes, rules and practices that support the effective, efficient, and ethical management and control of the enterprise. The policy may include, for example, the establishment and enforcement of policies, procedures, and operational controls designed to guide decision-making, resource allocation, risk management, regulatory compliance, and stakeholder engagement. In some embodiments, the governance agent 18 can reference or utilize governance policies and procedures that are defined, documented, or incorporated within one or more enterprise playbooks. The playbooks may serve as structured repositories of enterprise knowledge, including governance-related content, such as compliance guidelines, ethical standards, regulatory protocols, and operational best practices. The governance agent 18 can perform various functions in support of enterprise governance, including but not limited to enforcing enterprise rules and policies, monitoring compliance with legal, regulatory, or internal standards, and identifying and mitigating operational or strategic risks. The functions can also include facilitating efficient use and allocation of resources, providing data-driven insights and recommendations to support decision-making, and promoting transparency and accountability across enterprise functions.

The governance agent 18 can include memory 34, tools unit 36, and a self-assessment unit 38. The governance agent 18 can also employ a generative language model that can be trained on training data that includes governance related information set forth lin one or more governance playbooks associated with the enterprise. Once trained on the training data, the governance agent 18 monitors the data for compliance with or breaches or violations of the governance rules or policies of the enterprise as set forth in the governance playbook. The governance agent 18 operates within the enterprise to ensure compliance with regulations, policies, and ethical standards of the enterprise, while also optimizing processes, mitigating risks, and promoting transparency and accountability. The governance agent 18 continuously monitors organizational governance policies, rules, regulations, and compliance requirements relevant to the industry or jurisdiction of the enterprise. The governance agent 18 can analyze documents, contracts, and communications to ensure adherence to legal and regulatory frameworks, industry standards, and internal policies. The governance agent 18 can also assess potential risks associated with business operations, transactions, or decisions by analyzing data 12, identify any associated risk factors, and provide recommendations for mitigating risks or implementing risk management strategies. The governance agent 18 can also generate reports and documentation for audit, compliance, or regulatory purposes. The governance agent 18 can also compile relevant data, track compliance metrics, and provide insights into the organization's adherence to legal and regulatory requirements. The governance agent 18 can also assist decision-makers in evaluating strategic initiatives, investments, or policy changes, or can evaluate the initiatives and provide recommendations to decision makers. The agent can apply governance frameworks, decision models, and risk assessment methodologies to support informed decision-making aligned with organizational objectives.

According to another practice, the AI agents of the present invention can be continuously trained or self-trained to learn new processes associated with selected playbooks. A multi-agent orchestration platform that senses when action is needed, then engages the right teams and people at the right time for the right work.

According to another aspect of the present invention, the decisions of the various AI agents can be logged for auditability and continuous improvement of the agent's decision making. Further, the agent subsystem 20 can include the ability to identify areas of agent activity that are underperforming, thus requiring further fine tuning or corrective action of the agents. The agent deployment system 10 of the present invention can also include the ability to measure the number of decisions being made by the AI agents, including for example other metrics. According to one embodiment, the agent deployment system 10 can further include a decision tracking or logic monitoring unit that can be configured to quantify and log the number of decisions made by one or more AI agents during operation. A decision for purposes of measurement can be defined as an instance in which the AI agent selects one outcome from a set of alternatives based on an evaluation of input data, task state, or environmental conditions. Measurement of such decisions can be achieved through various techniques. For example, each AI agent can include embedded instrumentation logic at predefined decision points, such as control flow branches, classification outputs, policy selections, or action triggers, where a counter is incremented upon each decision event. The system may also implement structured event logging, with each log entry corresponding to a discrete decision and optionally including metadata such as context, input features, timestamp, and confidence score. In implementations where agents rely on machine learning models, decisions can be tracked by monitoring each generation of model output that results in a downstream action or state transition. Additionally, for multi-step or goal-oriented agents, decisions can be inferred from transitions between task states (e.g., from data gathering to execution), with each transition tagged and counted. Agents that employ decision policies, whether rule-based or learned, can expose policy evaluation hooks to log each invocation and selection outcome. In interaction-heavy systems, decisions can also be inferred from externally visible actions, such as user responses, API calls, or message exchanges between agents, where such interactions are decision-dependent. The measured decision counts may be further categorized by decision type (e.g., classification, escalation, or confidence-based deferral) and enriched with metadata such as agent identification information, source data type, or operational context to enable granular analytics. In some embodiments, this measurement capability also supports related metrics, such as decision frequency, decision accuracy, escalation versus resolution rates, and decision latency, which can be used to evaluate and improve the operational performance and trustworthiness of the AI agents deployed across the enterprise.

The AI agents can be configured to be separate of security controls, where process AI agents can include a defined management structure that is different from helper AI agents (admin) and people agents (individuals). The agent deployment system can include a control unit that includes the ability to govern or control the agents based on classification of the agents and scope of impact of the AI agent on the enterprise.

The agent subsystem 20 can be configured to identify the correct set of AI agents to engage in a process flow and can be configured to dynamically adapt the process flow when a new relevant AI agent is added to the agent subsystem. For example, a new brand governance agent can be created and inserted on an agent orchestration platform, and all workflows adapt as appropriate to include the brand governance agent in their workflows. The agent deployment system 10 can be further configured to canvas AI agent activity to find similar efforts, and aggregating efforts into consolidated programs and initiatives. The ability to provide for user oversight and insights of aggregated efforts for prioritization of work can also be performed by the agent deployment system of the present invention. The AI agents of the present invention can also be configured for narrow, specific domains, where the agents can be more consistent in their outputs, and manageable in their scope and contained impact.

The agent deployment system of the present invention also contemplates having users (e.g., employees) create individual AI agents, where each agent is configured to assist with employee-specific workflows. The individual AI agents can be grouped or classified into teams based on common use cases or functions or based on other factors. If the user is part of business team, then the team leader can create an AI agent to coordinate tasks across team members' agents and serve as the liaison among the AI agents of different teams. The control agent can be configured to canvass all AI agents within the organization to assemble task-specific teams based on the trigger event data. Further, the agent deployment system can be configured to receive automation triggers from external systems, wherein the control agent formulates response plans and assigns tasks to the relevant AI agent or AI agent teams. Each of the AI agents can be configured with autonomy settings determined by the users, thus dictating the agent's scope of autonomous action versus instances requiring human intervention. The AI agents can be trained by the users to recognize scenarios for autonomous action or human engagement based on past interactions and user preferences.

The agent deployment system 10 of the present invention is also directed to the orchestration of a multi-agent 26 end to end workflow sequence, where the system 10 selects, deploys, and orchestrates the right set of AI agents, at the right time, and in the right sequence, to execute on an end-to-end business workflow, and with control and governance agents to oversee and optimize the workflow. The agents can be trained to detect and engage with other agents based on the specific business workflows. The agent orchestration and sequencing can vary by business process and optimization techniques.

It is to be understood that although the invention has been described above in terms of particular embodiments, the foregoing embodiments are provided as being illustrative only, and are not intended to limit or define the scope of the invention. Various other embodiments, including but not limited to those described herein are also within the scope of the claims and current invention. For example, the foregoing elements, units, modules, tools, and components described herein can be further divided into additional components or sub-components or joined together to form fewer components for performing the same functions.

Any of the functions disclosed herein can be implemented using means for performing those functions. Such means include, but are not limited to, any of the components or units disclosed herein, as well as known electronic and computing devices and associated components.

The techniques described herein can be implemented, for example, in hardware, one or more computer programs tangibly stored on one or more computer-readable media, firmware, hardware or any combination thereof. The techniques described herein can be implemented in one or more computer programs executing on (or executable by) a programmable computer or electronic device having any combination of any number of the following: a processor, a storage medium readable and/or writable by the processor (including, for example, volatile and non-volatile memory and/or storage elements), an input device, an output device, and a display. Program code can be applied to input entered using the input device to perform the functions described and to generate output using the output device.

The term computing device or electronic device as used herein can refer to any device, such as a computer, smart phone, smart watches, smart glasses, servers and the like, that includes a processor and a computer-readable memory capable of storing computer-readable instructions, and in which the processor is capable of executing the computer-readable instructions in the memory. The terms electronic device, computer system and computing system can refer to a system containing one or more computing devices that are configured to implement one of more units, modules, or components of the system 10 of the present invention.

Embodiments of the present invention include features which are only possible and/or feasible to implement with the use of one or more computers or servers, processors, and/or other elements of a computer or server system. Such features are either impossible or impractical to implement mentally and/or manually. For example, embodiments of the present invention can operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which by implication or affirmatively require an electronic device such as a computer or server, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claims herein which recites that the claimed method is performed by a computer, a processor, a memory, and/or similar computer-related element, is intended to, and should only be interpreted to, encompass methods which are performed by the recited electronic device or computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to enrich and manage prompts. There is no analog to this problem in the non-computer environment, nor is there an analog to the solutions disclosed herein in the non-computer environment.

Furthermore, embodiments of the present invention represent improvements to computer and communication technology itself. For example, the system 10 of the present invention can optionally employ a specially programmed or special purpose computer in an improved computer system, which can, for example, be implemented within a single computing device. In the present invention, the system 10 of the present invention results in an improved and enhanced computing system that better enables the user to select a team of AI agents based on selected trigger event data. The system 10 thus results in a specially configured computing system. Consequently, the system 10 by employing the units and agents set forth herein increases the efficiency of the overall systems and increases the efficiency of selecting and deploying AI agents.

Each computer program within the scope of the claims below can be implemented in any programming language, such as assembly language, machine language, a high-level procedural programming language, or an object-oriented programming language. The programming language can, for example, be a compiled or interpreted programming language.

Each such computer program can be implemented in a computer program product tangibly embodied in a machine-readable storage device for execution by a computer processor. Method steps of the invention can be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing can be supplemented by, or incorporated in, specially designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which can be used in conjunction with any digital print engine or marking engine, display monitor, or other raster output device capable of producing color or gray scale pixels on paper, film, display screen, or other output medium.

Any data disclosed herein can be implemented, for example, in one or more data structures tangibly stored on a non-transitory computer-readable medium. Embodiments of the invention can store such data in such data structure(s) and read such data from such data structure(s).

It should be appreciated that various concepts, systems and methods described above can be implemented in any number of ways, as the disclosed concepts are not limited to any particular manner of implementation or system configuration. Examples of specific implementations and applications are discussed herein are primarily for illustrative purposes and for providing or describing the operating environment of the system of the present invention. The system 10 and/or elements or units thereof can employ one or more electronic or computing devices, such as one or more servers, clients, computers, laptops, smartphones and the like, that are networked together, or which are arranged so as to effectively communicate with each other. The network can be any type or form of network. The devices can be on the same network or on different networks. In some embodiments, the network system can include multiple, logically grouped servers. In one of these embodiments, the logical group of servers can be referred to as a server farm or a machine farm. In another of these embodiments, the servers can be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like. The system 10 and/or any associated units or components of the system can employ one or more of the illustrated computing or electronic devices and can form a computing system. Further, the server can be a file server, application server, web server, proxy server, appliance, network appliance, gateway, gateway server, virtualization server, deployment server, SSL VPN server, or firewall, or any other suitable electronic or computing device. In one embodiment, the server can be referred to as a remote machine or a node. In another embodiment, a plurality of nodes can be in the path between any two communicating servers or clients.

We claim:

1. A computer-implemented agent deployment system for adaptive management of a plurality of artificial intelligence (AI) agents within an enterprise computing environment of an enterprise, the system comprising
an agent subsystem having a control agent configured to:
receive source data from one or more data sources of the enterprise,
continuously monitor the source data for an occurrence of a trigger event indicative of a condition requiring an AI based intervention by the plurality of AI agents,
detect the trigger event,
evaluate the trigger event to identify a relevant operational context, and
based on the trigger event and the operational context, select and deploy the plurality of AI agents from a total set of AI agents to address the trigger event by performing an AI-based intervention,
wherein the selected plurality of AI agents are dynamically instantiated, activated, or reconfigured for event-specific processing, and
a governance agent configured to manage a governance policy in a governance playbook of the enterprise.

2. The computer-implemented system of claim 1, wherein the control agent comprises a machine learning model that is trained on one or more playbooks of the enterprise so as to determine the existence of the trigger event related to the playbooks that requires the AI based intervention.

3. The computer-implemented system of claim 2, wherein the control agent further comprises
a self-assessment unit for evaluating the performance of the control agent during operation within the enterprise computing environment,
a detection unit for applying a detection technique to the source data for detecting the trigger event in the source data, and
an agent selection unit for selecting the plurality of agents based on the trigger event and the operational context.

4. The computer-implemented system of claim 3, wherein the control agent further comprises a characterization unit for applying a classification technique to the plurality of control agents for characterizing the AI agents into one of a plurality of categories.

5. The computer-implemented system of claim 4, wherein each of the plurality of agents comprises an agent machine learning model that is trained on training data that includes data associated with at least one of the playbooks of the enterprise.

6. The computer-implemented system of claim 4, wherein each of the plurality of agents comprises an agent machine learning model that is trained on training data that includes actions and behaviors of a selected user.

7. The computer-implemented system of claim 3, wherein the governance agent comprises a governance machine learning model that is trained on training data that includes data associated with the governance playbook of the enterprise.

8. A computer-implemented method for adaptive management of a plurality of artificial intelligence (AI) agents within an enterprise computing environment of an enterprise, the method comprising
providing an agent subsystem having a control agent configured to:
receive source data from one or more data sources of the enterprise,
continuously monitor the source data for an occurrence of a trigger event indicative of a condition requiring an AI based intervention by the plurality of AI agents,
detect the trigger event,
evaluate the trigger event to identify a relevant operational context, and
based on the trigger event and the operational context, select and deploy the plurality of AI agents from a total set of AI agents to address the trigger event by performing an AI-based intervention, wherein the selected plurality of AI agents are dynamically instantiated, activated, or reconfigured for event-specific processing, and
providing a governance agent configured to manage a governance policy in a governance playbook of the enterprise.

9. The computer-implemented method of claim 8, further comprising configuring the control agent to include a machine learning model, and training the machine learning model on one or more playbooks of the enterprise so as to determine the existence of the trigger event related to the playbooks that requires the AI based intervention.

10. The computer-implemented method of claim 9, further comprising configuring the control agent to:
evaluate the performance of the control agent with a self-assessment unit during operation within the enterprise computing environment,
apply a detection technique to the source data with a detection unit for detecting the trigger event in the source data, and
select the plurality of agents with an agent selection unit based on the trigger event and the operational context.

11. The computer-implemented method of claim 10, wherein the control agent is further configured to apply a classification technique to the plurality of control agents for characterizing the AI agents into one of a plurality of categories.

12. The computer-implemented method of claim 11, further comprising configuring each of the plurality of agents to include an agent machine learning model, and training the agent machine learning model on training data that includes data associated with at least one of the playbooks of the enterprise.

13. The computer-implemented method of claim 11, further comprising configuring each of the plurality of agents to include an agent machine learning model, and training the agent machine learning model on training data that includes actions and behaviors of a selected user.

14. The computer-implemented method of claim 10, further comprising configuring the governance agent to include a governance machine learning model, and training the governance machine learning model on training data that includes data associated with the governance playbook of the enterprise.
